(19) United States
(12) Patent Application Publication
(10) Pub. No.: US 2020/0021694 A1
(43) Pub. Date: Jan. 16, 2020

(54) IMAGE FORMING APPARATUS

(71) Applicant: Konica Minolta, Inc., Tokyo (JP)

(72) Inventors: Satoshi OGATA, Tokyo (JP); Yumiko IZUMIYA, Tokyo (JP); Kazutoshi YOSHIMURA, Tokyo (JP); Tatsuhiro NOUTOMI, Tokyo (JP); Sayaka OGASAWARA, Tokyo (JP)

(21) Appl. No.: 16/448,002

(22) Filed: Jun. 21, 2019

(30) Foreign Application Priority Data
Jul. 11, 2018 (JP) 2018-131284

(51) Int. Cl. H04N 1/00

(52) U.S. Cl. CPC H04N 1/00092; H04N 1/00482; H04N 1/00045; H04N 1/00034

(57) ABSTRACT

An image forming apparatus includes the following. A measuring unit measures a physical property of media as a target on which an image is formed. An image forming operator forms an image on the media. A hardware processor controls an operation of the image forming operator and extracts a candidate of a type of media based on a measured result by the measuring unit. An operation receiver receives input to specify one type from the candidate extracted by the hardware processor. The hardware processor controls the image forming operator to form on the media an identification image determined according to a combination of the extracted candidates.

### BACKGROUND

### 1. Technological Field

The present invention relates to an image forming apparatus.

### 2. Description of the Related Art

Conventionally, the image forming apparatus forms an image by applying color material to media (recording media). Toner and ink are widely used as color material. Media include paper media. Paper media include normal sheets and high quality sheets, and exist in various sheet thicknesses, various smoothness degrees of the media surface and various basis weights. Paper media suitable for the purpose of image forming are selected and used.

When images are formed on various media, various parameters such as the amount of the color material are adjusted according to physical properties of the media, and the conditions are optimized to output the desired image. If the operator of the image forming apparatus adjusts the parameters manually, the burden increases. Moreover, the image needs to be repeatedly formed until the optimal state is achieved, and the amount of media used increases.

In view of the above, Japanese Patent Application Laid-Open Publication No. 2006-44039 discloses a technique in which a relation between a plurality of types of media and parameter settings are held in advance, a simple media sensor is provided to measure the physical properties of the media to narrow down the type of sheet, and the user selects the sheet type from the candidates. With this, the burden of the user is reduced. Japanese Patent Application Laid-Open Publication No. 2016-215452 discloses a technique in an inkjet recording apparatus which records a test image including lines with various thicknesses in various directions and which reads the degree of blur in each line to determine the media type according to the combination of the type of line and the degree of blur.

However, if an attempt is made to specify one type from various media, there is a problem that the amount of the media and the color material necessary increases in order to form the test image with which all types of media can be judged, and much resources are wasted. Moreover, if the user does not understand the types of media, the user cannot make the correct choice even if the options are narrowed down. Therefore, there is still a burden to the user and further, knowledge becomes necessary.

### SUMMARY

The object of the present invention is to provide an image forming apparatus which can judge a type of media efficiently and reliably.

To achieve at least one of the abovementioned objects, according to an aspect of the present invention, an image forming apparatus reflecting one aspect of the present invention is described, the image forming apparatus including: a measuring unit which measures a physical property of media as a target on which an image is formed; an image forming operator which forms an image on the media; a hardware processor which controls an operation of the image forming operator and which extracts a candidate of a type of media based on a measured result by the measuring unit; and an operation receiver which receives input to specify one type from the candidate extracted by the hardware processor, wherein, the hardware processor controls the image forming operator to form on the media an identification image determined according to a combination of the extracted candidates.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a schematic diagram showing an overall configuration of an image forming apparatus according to the present embodiment.

FIG. 2 is a block diagram showing a functional configuration of the image forming apparatus.

FIG. 3 is a table showing an example of an identification target information.

FIG. 4A is a diagram showing an example of an identification image.

FIG. 4B is a diagram showing an example of an identification image.

FIG. 4C is a diagram showing an example of an identification image.

FIG. 4D is a diagram showing an example of an identification image.

FIG. 5A is a diagram showing an example of display contents in a display screen on a display.

FIG. 5B is a diagram showing an example of display contents in a display screen on a display.

FIG. 6 is a diagram showing an example of display contents in a display screen on a display.

FIG. 7 is a flowchart showing a control procedure in a recording setting process.

FIG. 8 is a flowchart showing a control procedure of a media measuring process called in the image setting process.

FIG. 9 is a block diagram showing a functional configuration of an image forming apparatus of other embodiments.

FIG. 10 is a flowchart showing the control procedure of the recording setting process.

### DETAILED DESCRIPTION OF EMBODIMENTS

Hereinafter, one or more embodiments of the present invention will be described with reference to the drawings. However, the scope of the invention is not limited to the disclosed embodiments.

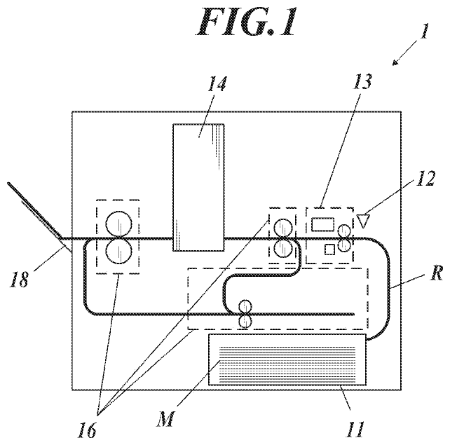

FIG. 1 is a schematic diagram showing an overall configuration of the image forming apparatus 1 of the present embodiment.

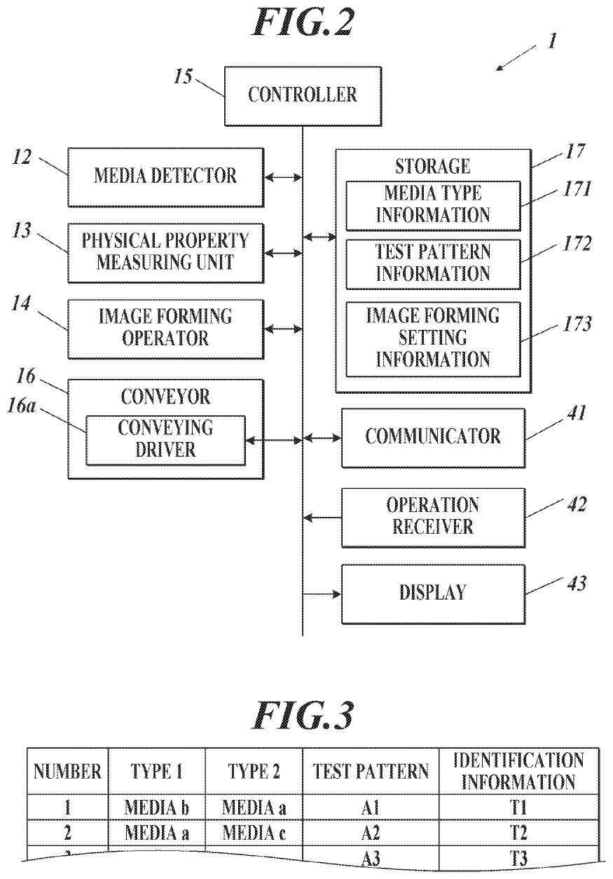

The image forming apparatus 1 is an image forming apparatus which forms an image applying the color material to the media M and attaches and fixes the toner to the media M in an electro-photographic method, for example. The image forming apparatus 1 includes a media supplier 11, a media detector 12, a physical property measuring unit 13 (measuring unit), an image forming operator 14, a controller 15 (see FIG. 2), a conveyor 16, and an ejection tray 18.

The media supplier 11 includes the tray and holds media M (recording medium) which are the target of image forming. The media supplier 11 sends the media M to a conveying route R at a suitable timing according to the control by the controller 15. The conveyor 16 moves the media M along the conveying route R at a certain speed. The conveyor 16 includes rollers which hold the media M in between to advance the media M and includes the rotating motors which rotate the rollers. The conveyor 16 includes a reversal unit which reverses the front and the rear of the media M formed on one side of the image to form the image again.

The media detector 12 detects the media M moving on the conveyor route R conveyed by the conveyor 16 at a predetermined position, here the position a predetermined distance before the position where the image is formed by the image forming operator 14. For example, the media detector 12 includes an optical sensor (photodiode). The media detector 12 detects whether the media M exist by determining whether the light is blocked by the media M. Alternatively, the media detector 12 detects whether the media M reached the predetermined position according to the change in the strength detected by the reflected light depending on whether the media M exist. The image forming timing is controlled by the image forming operator 14 and the image is formed in a suitable position on the media M based on the timing that the front tip of the media M is detected by the media detector 12 and the conveying speed by the conveyor 16.

The physical property measuring unit 13 measures the physical quantity regarding the physical property of the media M. The (obtainable) physical property of the target of measurement is not limited and may include thickness, basis weight and smoothness degree of the surface, for example. The method of measurement is not limited. For example, the thickness is measured by displacement rollers which detect intervals between axes of two rollers which can move in the thickness direction according to the thickness of the media M. The degree of smoothness can be obtained based on a strength ratio using a reflecting sensor which outputs strength of the specular reflected light and the scattered reflected light and/or the strength ratio of the scattered reflected light and the specular reflected light of the irradiated light (mixed light of infrared light and visible light with a predetermined wavelength). The basis weight is calculated based on measured values such as the amount of irradiated light passing through the media M and the above-described thickness. The result of a weight sensor which directly measures the weight of the media M can be used in calculating the basis weight.

The measurement operation by the physical property measuring unit 13 is performed in a plurality of positions of the media M while pausing the movement of the media M every predetermined distance, and the result of calculations such as calculating the average of the plurality of obtained values is used as the final physical property value.

The physical property measuring unit 13 is not limited to those mounted internally in the image forming apparatus 1 and may be attached and operable from outside according to necessity. In this case, a connecting unit for lines regarding power supply to the physical property measuring unit 13 and transmission/reception of signals are provided inside the image forming apparatus 1.

The image forming operator 14 includes an image forming engine (print engine) which forms an image on the media M by attaching and fixing color material such as toner and ink on the media M. Although not limited, the image forming operator 14 forms (exposes) on a photoreceptor toner images in four colors of CMYK with an electro-photographic method, and forms the color image transferred through a transferring body on the media M.

The media M which are sent out from the media supplier 11 and moved on the conveying route R are ejected on the ejection tray 18. Before the ejection tray 18, post processors which perform various post processing such as cutting and sorting can be connected.

FIG. 2 is a block diagram showing the functional configuration of the image forming apparatus 1 according to the present embodiment.

In addition to the above-described media detector 12, the physical property measuring unit 13, and the image forming operator 14, the image forming apparatus 1 includes a controller 15 (operation controller, extractor), a conveying driver 16a, a storage 17, a communicator 41, an operation receiver 42, and a display 43.

The controller 15 is a hardware processor which centrally controls various operations in the image forming apparatus 1. The controller 15 includes a Central Processing Unit (CPU), and a Random Access Memory (RAM). In the controller 15, the control program stored in the storage 17 is read out, and the control program is executed by the CPU. With this, the controller 15 controls the image forming operation by the image forming operator 14, and the calibration and setting of the image forming operation. As described later, the controller 15 performs the recording setting process to extract and specify the candidates of the type of media M as the target on which the image is formed, and performs the setting regarding the image forming operation based on the specified result.

The conveying driver 16a outputs a driving signal so that the motor of the conveyor 16 rotates based on control by the controller 15 and the media supplier 11 supplies media. With this, the conveying operation of the media M is performed and the conveying speed is adjusted.

The storage 17 stores programs executed by the controller 15, setting data used in the program, image data regarding the image as the target to be formed by the image forming operator 14, and the like. The storage 17 includes a nonvolatile storage medium such as a Hard Disk Drive (HDD) or a flash memory. The storage 17 includes a RAM, and the RAM may be used to temporarily store and process some of the data.

The storage 17 stores as setting data media type information 171, test pattern information 172, and image forming setting information 173.

The media type information 171 includes a list which links in advance the type of media which may be the target of image forming with the property information of the type of media. For example, the target media includes, normal sheet, high quality sheet, glossy sheet, mat sheet, and shiny sheet. Various thicknesses can be set for the same type of media. The property values such as thickness, smoothness degree, and basis weight are corresponded to each type of media.

The test pattern information 172 includes image data of a pattern image (identification image) which is formed on the media to enable identification of differences among plurality of types of media which have similar property values and which are hard to distinguish, and list information of the media type as targets of identification by the image data (information regarding combination). The pattern image is used to be able to identify only media with similar property values, and other media types which can be distinguished based on the physical property value do not have to be considered. The media with similar property values are usually two types, but may include three or more types. The pattern image does not have to be a single image and can be a combination of two or more types of images. However, the number of images need only to be the minimum necessary. For example, when there are three types of candidates, the image can be formed so that it can be determined that if the first test pattern is normal, the media type is the first candidate, if the second test pattern is normal, the media type is the second candidate, and if the first test pattern and the second test pattern are not formed normally, the media type is the third candidate.

The communicator 41 controls communication performed between external communication devices based on predetermined communication standards. As the communication standard, for example, the communication standard (TCP/IP, etc.) by Local Area Network (LAN) is used. The communicator 41 includes a network card to perform communication control by the LAN.

The operation receiver 42 receives input operation from outside such as the user and outputs to the controller 15 the received contents as the input signal. The operation receiver 42 includes, for example, the touch panel provided overlapped with the display screen of the display 43 and the press button switch. The input signal includes the information regarding the pressing operation of the press button switch, and the touch operation and the touched position on the touch panel.

The controller 15 controls the display 43 to display contents on the display screen. The display contents include the status regarding the image forming operation and the setting menu to receive input operation from the user. The display screen is not limited and includes a liquid crystal display (LCD) and an organic electroluminescent (EL) display. The display 43 includes an LED lamp and may notify the state of power supply and the state of errors.

Next, the setting operation regarding the forming of the image in the image forming apparatus 1 according to the present embodiment is described.

When the image is formed in the image forming apparatus 1, the properties of the formed image are different depending on the media type on which the image is formed. Such properties include penetration of the color material to the media, degree of fixing, and degree of spreading (blur). Therefore, even if the image based on the same image data is formed, various conditions such as suitable applying amount of color material, contrast, line thickness and fixing temperature need to be changed. In order to form the optimal image based on the image data, the preferable settings of the image processes and the image forming operations are changed for each type of media M in the image forming apparatus 1.

In the image forming apparatus 1, the plurality of types of media M can be narrowed down to a certain degree based on the measured results by the physical property measuring unit 13. However, according to the range which can be measured by the physical property measuring unit 13, it may be difficult to specify one media type depending on the measured physical property value. According to the image forming apparatus 1 of the present embodiment, a predetermined test image is formed on the media M in which the physical properties are measured, the test image is read by the user, and based on the read result of the test image, the type of media M is specified from the type candidates which remain after narrowing down the type candidates. The type of media M as the target of specifying includes the combination of the plurality of media types (mainly two types) which are assumed in advance to be difficult to discriminate by the physical property measurement. The test image includes the image with which the media type for such combination can be easily discriminated according to the formed result of the test image.

FIG. 3 is a table showing an example of identification target information.

The identification target information shows that a test pattern image A1 is used as an identification image when a media type with type 1 and a media type with type 2 are difficult to discriminate with only the physical property value and if the combination is extracted as the candidate. For example, here, it may be determined that if the test pattern image A1 is formed on the media M with the type 1, the image is recorded normally, and if the test pattern image A1 is formed on the media M with the type 2, a specific abnormality occurs in the image quality (image quality reduction), or vice versa. As described later, the identification information T1 is stored corresponded in the identification target information to display to the user the detailed contents of such specific image quality abnormality (image quality reduction).

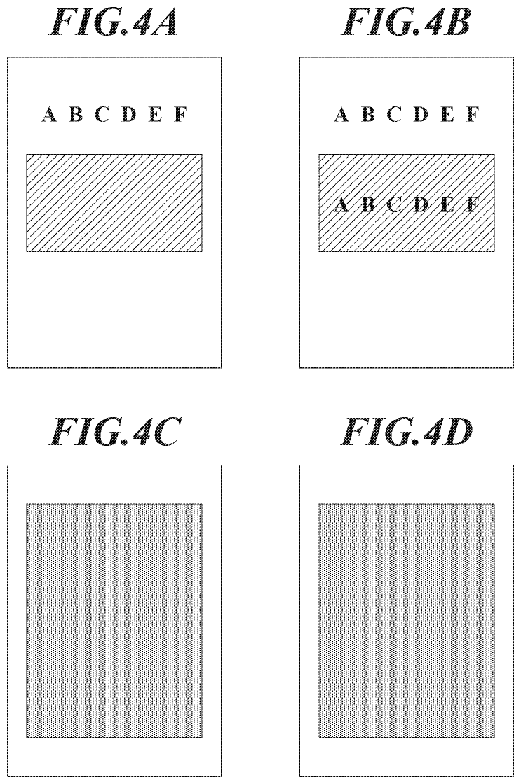

FIG. 4A to FIG. 4D are diagrams showing examples of the identification image. EST

FIG. 4A is a test pattern image corresponding to the test pattern A shown in FIG. 3. A predetermined character string is formed in the upper side and a solid region is formed in the middle. The middle position is the position corresponding to one cycle of the fixing roller after the upper position. If the release agent to easily release the media M from the fixing roller is fixed to the fixing roller, depending on the type of media M, the unevenness in the shininess (shiny memory) of the image quality in the shape corresponding to the image forming pattern in the previous cycle may become severe in the next cycle of the fixing roller due to influence of the release agent remaining on the fixing roller, as shown in FIG. 4B. Here, the media M is identified according to the degree of the shiny memory occurring.

As the test pattern B (identification image), a blue solid image is formed on both surfaces of the media M as shown in FIG. 4C and FIG. 4D. In such image, unevenness in the density of the solid image tend to occur on the rear surface side if suitable setting is not performed. If the test pattern B is formed on the media c with the setting for the media a, it is possible to identify the media type due to unevenness in the density occurring in the rear surface side in the non-negligible degree.

If such test pattern image is formed on media other than the media a and the media c with the setting for media a, the setting is far from the suitable setting for such media. Therefore, the image is not fixed properly, toner is scattered and attached around the conveying route R and the surroundings become stained. This causes problems such as stains attaching in media that follow. The test pattern image is formed on only the media M as the target of identification. Therefore, it is possible to easily perform the necessary identification of media type without providing a bad influence to the image forming apparatus 1.

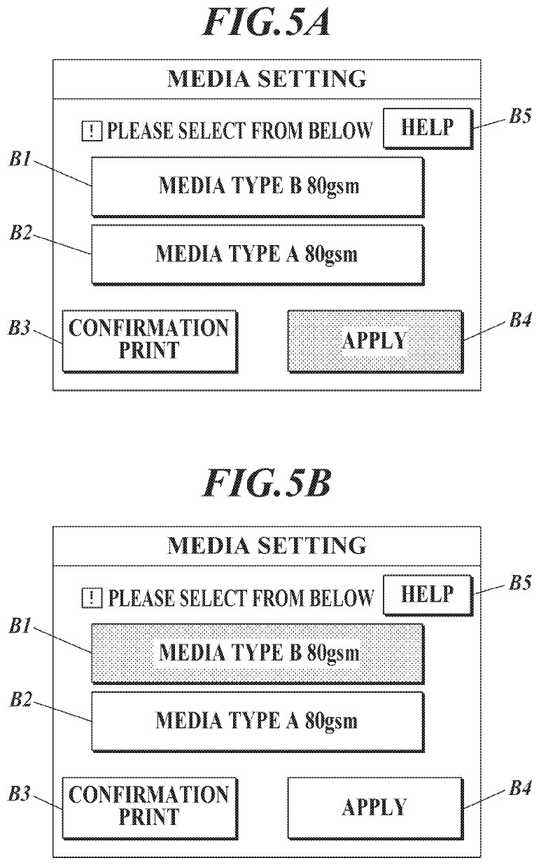

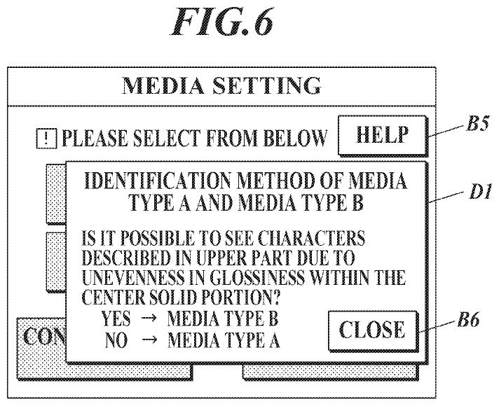

FIG. 5A, FIG. 5B, and FIG. 6 are diagrams showing examples of contents displayed in the display screen of the display 43 when a plurality of media type candidates are extracted by the detecting operation by the physical property measuring unit 13.

Here, for example, as shown in FIG. 5A, an example of display when a glossy sheet and a mat sheet with a basis weight of 80 gsm are extracted as the media type candidates from the obtained physical property value. The display screen displays the selection buttons B1 and B2 for the extracted candidates (media type A, B). The display screen displays the button B3 requesting “confirmation print” together with the above. If input operation touching this button B3 is detected, the test pattern image corresponding to the extracted candidate is formed as an image on the media M.

As shown in FIG. 5B, the user determines the formed test pattern image by sight, determines the media type (close media type), and inputs by touching either the selection button B1 or B2 listed as the candidates. Then, further, by touching “apply” button B4 for the selection, the selected contents are confirmed. If the user knows the type of media M without outputting and confirming the test pattern image, the user may select any of the candidates without touching “confirmation print” button B3.

As a result of confirmation printing, the user can obtain knowledge of which image to select in which state by touching a help button B5. With this, as shown in FIG. 6, the description showing the method of identification based on the identification information included in the media type information 171 is displayed in the popup screen D1. If a button B6 displaying “close” in the popup screen D1 is touched, the popup screen D1 is erased and the display returns to the original display.

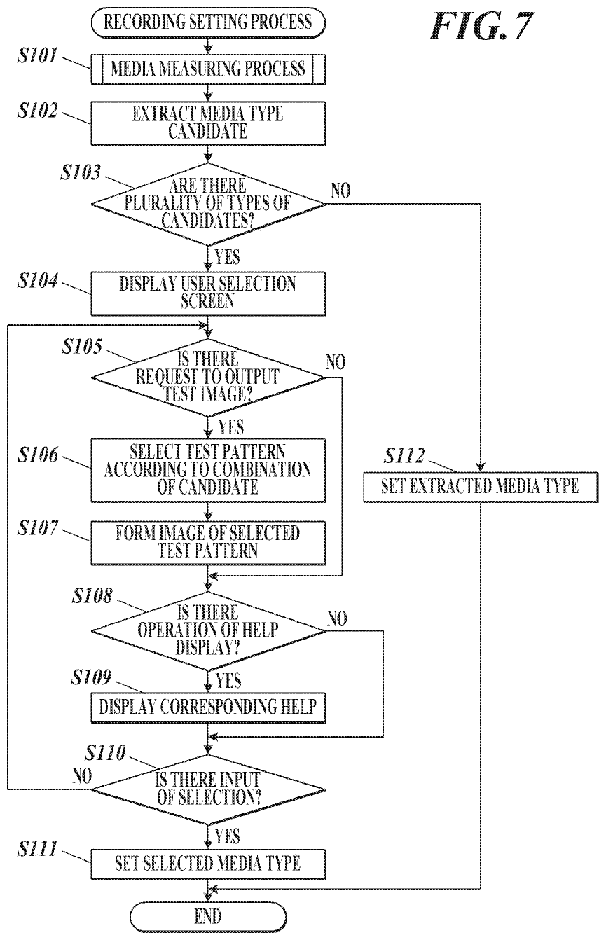

FIG. 7 is a flowchart showing a control procedure by the controller 15 regarding a recording setting process performed in the image forming apparatus 1 according to the present embodiment.

The recording setting process starts when the operation receiver 42 receives the predetermined input operation.

When the recording setting process starts, the controller 15 calls and executes the media measuring process (step S101). The controller 15 extracts the candidates from the list of media types based on the measured result (step S102). The process regarding extracting may be performed quantitatively (evaluation of points) based on the measurement data. For example, the controller 15 calculates the values showing the degree of difference from the reference value of each type of media M held in advance for each measured value regarding the physical properties or a predetermined calculated value based on the measured value. The values showing the degree of difference is normalized for each reference value and added. Then, the controller 15 extracts as the candidate the type with the added value (point) of the degree of difference regarding the measured value of the plurality of types as the target of evaluation or the calculated value being smaller (satisfying the predetermined condition) than the reference value. In this case, the number of types which satisfy the predetermined condition is not limited. Therefore, one may be extracted from the beginning or three or more may be extracted.

The controller 15 determines whether the candidates are a plurality of types (step S103). If it is determined that the number of types is not plural (it is one type) (“NO” in step S103), the controller 15 specifies the extracted candidate as the media type (step S112). Then, the controller 15 ends the recording setting process.

If it is determined that the number of types of candidates is a plurality of types (“YES” in step S103), the controller 15 outputs the control signal to the display 43 and displays the user selection screen including the plurality of candidates which are extracted and the request button of the confirmation print (step S104). The controller 15 determines whether the input operation regarding the test image output request (instruction to form the identification image) is obtained (received) by the operation receiver 42 (step S105). If it is determined that it is not obtained (“NO” in step S105), the process by the controller 15 proceeds to step S108.

If it is determined that the test image output request is obtained (received) (“YES” in step S105), the controller 15 refers to the identification target information and selects the test pattern defined in advance according to the combination of the plurality of extracted candidates (step S106). The controller 15 outputs a control signal to the image forming operator 14 to form an image of the test pattern on the media M (step S107). Here, the operation setting regarding the image forming can be determined to be suitable in any of the candidates. Then, the process by the controller 15 progresses to step S108.

When the process progresses to step S108, the controller 15 determines whether the input to request the help display is detected (step S108). If it is determined that the input is detected (“YES” in step S108), the identification information T1 regarding the identification method corresponding to the test pattern defined in advance according to the combination of the plurality of extracted candidates is referred, and the control signal to display the contents (information regarding the identification method) on the display 43 is output to the display 43 (step S109). Then, the process in the controller 15 progresses to step S110. In the determining process in step S108, if it is determined that the input to request the help display is not detected (“NO” in step S108), the process in the controller 15 progresses to step S110.

When the process progresses to step S110, the controller 15 determines whether there is input to select and confirm (specify) any of the extracted candidates (step S110). If it is determined that there is no input of selection or confirmation (“NO” in step S110), the process by the controller 15 returns to step S105. If it is determined that there is input of selection or confirmation (“YES” in step S110), the controller 15 sets the media type as the selected candidate and performs the setting regarding the image forming operation according to the setting (step S111). Then, the controller 15 ends the recording setting process.

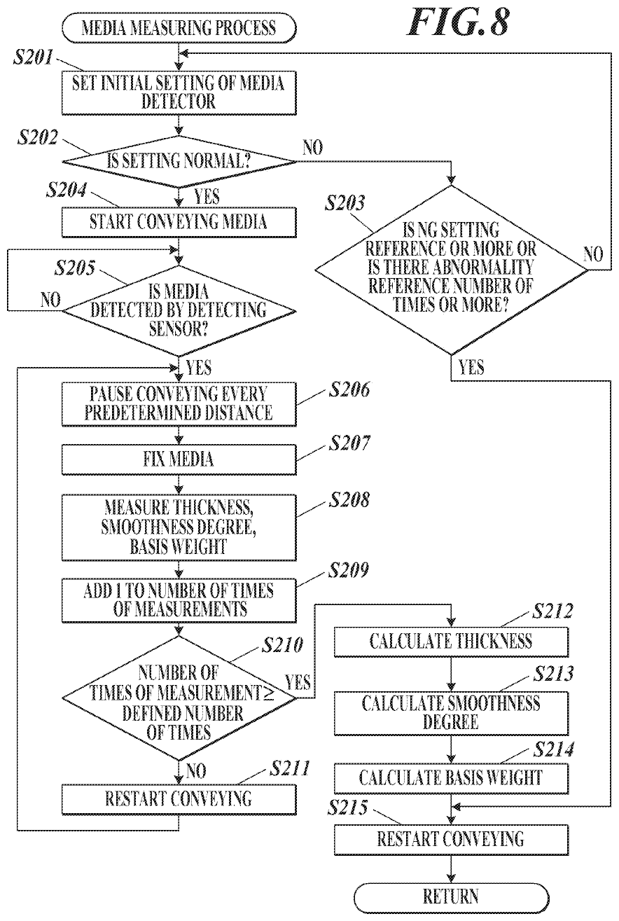

FIG. 8 is a flowchart showing the control procedure by the controller 15 regarding the media measuring process called by the image setting process.

When the media measuring process is called, the controller 15 performs the initial setting of the physical property measuring unit 13 (step S201). The controller 15 determines whether the initial setting is performed normally (step S202). If it is determined that the initial setting is not performed normally (“NO” in step S202), the controller 15 determines whether the point in which the initial setting is not good is equal to or more than a reference or whether the number of times that the initial setting is not performed normally is equal to or more than a reference (step S203). If the point in which the initial setting is not good is not equal to or more than the reference and the number of times that the initial setting is not performed normally is not equal to or more than (less than) the reference (“NO” in step S203) the process by the controller 15 returns to step S201.

If the point in which the initial setting is not good is equal to or more than a reference or the number of times that the initial setting is not performed normally is equal to or more than the reference (“YES” in step S203), the process by the controller 15 progresses to step S215.

If it is determined that the initial setting is performed normally in the determining process in step S202 (“YES” in step S202), the controller 15 outputs the control signal to the conveying driver 16a so that the conveyor 16 starts the conveying operation of the medium M as the setting target from the media supplier 11 (step S204). The controller 15 determines whether the media detector 12 detects the media M (step S205). If it is determined that the media M is not detected (“NO” in step S205), the controller 15 repeats the process in step S205.

If it is determined that the media detector 12 detected the media M (“YES” in step S205), the controller 15 pauses the conveying operation at the timing that the media M is conveyed a predetermined distance (step S206). The controller 15 applies pressure to the media M in a predetermined number of points (for example, 5 points) to fix the media M (step S207). The controller 15 operates the physical property measuring unit 13 to obtain the measurements such as the thickness of the media M, the smoothness degree of the media M, and the basis weight of the media M based on the measured result (step S208).

The controller 15 adds “1” to the number of times that the measurement is performed (step S209). The controller 15 determines whether the number of times that the measurement is performed is equal to or more than a defined number (step S210). If it is determined that the number of times that the measurement is performed is not equal to or more than (less than) the defined number (“NO” in step S210), the controller 15 allows the conveying driver 16a to resume the operation by the conveyor 16 (step S211). Then, the process by the controller 15 returns to step S206.

If it is determined that the number of times that the measurement is performed is equal to or more than the defined number (“YES” in step S210), the controller 15 calculates the thickness of the media M based on the results measured the defined number of times (step S212). The controller 15 calculates the degree of smoothness of the media M (step S213) and the basis weight of the media M (step S214). These calculations can simply be an average value of the values measured the defined number of times or an average of the measured values excluding the maximum value and the minimum value. Alternatively, as the calculated representative, the center value of the value measured the defined number of times can be used. Then, the process by the controller 15 progresses to step S215.

When the process in step S215 progresses from the process in steps S203, S214, the controller 15 allows the conveying driver 16a to resume the conveying operation by the conveyor 16 (step S215). Then, the controller 15 ends the media measuring process and returns to the recording setting process.

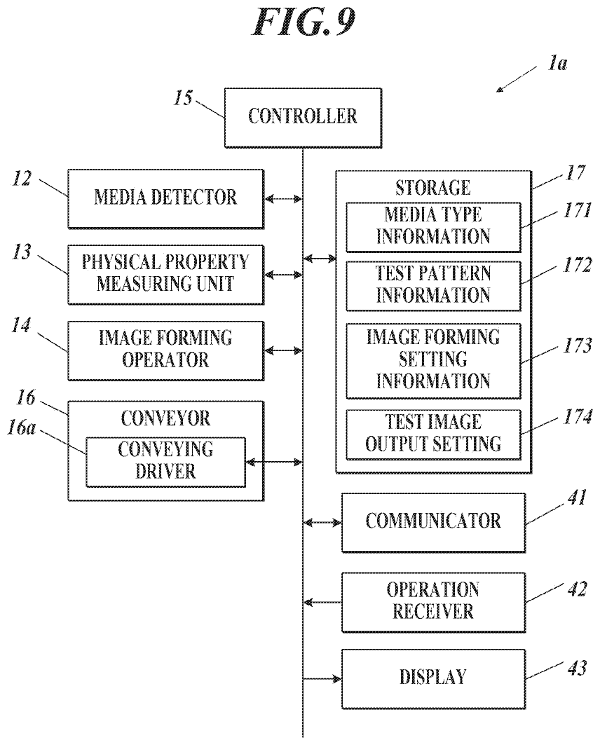

FIG. 9 is a block diagram showing a functional configuration of the image forming apparatus 1a according to another embodiment. The image forming apparatus 1a is the same as the image forming apparatus 1 of the above-described embodiment with the exception that a test image output setting 174 (setting) is stored in the storage 17 of the image forming apparatus 1a. The same reference numerals are applied to the same components and the description is omitted.

The test image output setting 174 is a setting to set in advance whether a predetermined input operation needs to be detected to form a test pattern image as described above if there are a plurality of candidates extracted based on the values measured by the physical property measuring unit 13 (whether the identification image is formed without waiting for the input operation). That is, if there are a plurality of extracted candidates, based on the test image output setting 174, the controller 15 determines whether the test pattern image according to the combination of the candidates is automatically formed without input operation regarding the instruction to output the test pattern. Such setting can be made by the operation receiver 42 receiving predetermined input operation or the communicator 41 obtaining setting from outside.

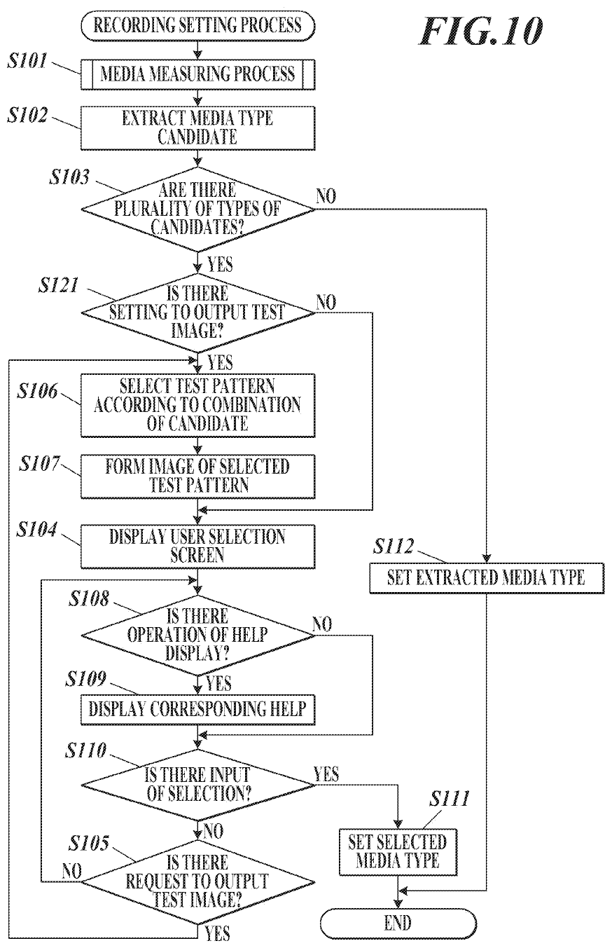

FIG. 10 is a flowchart showing the control procedure by the controller 15 regarding the recording setting process performed in the image forming apparatus 1a according to the present embodiment.

The process described in step S121 is added to the recording setting process shown in FIG. 7, and the position of the process in steps S104 and S105 is changed. The same reference numerals are applied to the contents which are the same in the processes shown in FIG. 7 and FIG. 10, and the detailed description is omitted.

In the determining process in step S103, if it is determined that there are a plurality of extracted candidates (“YES” in step S103), the controller 15 determines whether there is a setting to output the test images successively automatically (step S121). If it is determined that there is a setting to output automatically (“YES” in step S121), after performing the process in steps S106 and S107 and forming the image of the test pattern, the controller 15 progresses the process to step S104. If it is determined that the setting to output automatically is not performed (including setting to not output automatically) (“NO” in step S121), the process by the controller 15 progresses to step S104. After the process in step S104, the process by the controller 15 advances to step S108.

In the determining process in step S110, if it is determined that there is input of selecting and confirming any of the candidates (“YES” in step S110), the process by the controller 15 progresses to step S111. If it is determined that there is no input of selecting and confirming (“NO” in step S110), the process by the controller 15 progresses to step S105.

In the determining process in step S105, if it is determined that the output request of the test image is received (“YES” in step S105), the process by the controller 15 returns to step S106. After the process returns to step S106, if the process in step S104 is already performed, the controller 15 does not have to perform the process in step S104 again and can omit the process. If it is determined that the output request of the test image is not received (“NO” in step S105), the process by the controller 15 returns to step S108.

As described above, the image forming apparatus 1 according to the present embodiment includes the physical property measuring unit 13 which measures the physical property of the media M as the target of forming the image, the image forming operator 14 which forms the image on the media M, the controller 15, and the operation receiver 42. The controller 15 functions as the operation controller to control the operation of the image forming operator 14 and functions as the extractor to extract the candidates of the types of media M based on the results measured by the physical property measuring unit 13. The operation receiver 42 receives the input operation which specifies one type from the extracted candidates. The controller 15 functions as the operation controller to control the image forming operator 14 to form on the media M the image with the image pattern determined according to the combination of the extracted candidate.

As described above, according to the image forming apparatus 1, the necessary image pattern is selected and formed so that the candidates narrowed down by the physical property measurement can be identified. Therefore, the consumption of color material and media can be suppressed. The reference for determination by the user becomes small (specifically one in most cases) and the determination becomes clear and simple. Therefore, the trouble by the user can be reduced. The possibility that the test image is formed with a setting drastically different from the properties of the media M decreases. Therefore, trouble such as the fixing of the color material being insufficient and the inside of the image forming apparatus 1 becoming dirty can be suppressed. Therefore, the image forming apparatus 1 is able to discriminate the media type more efficiently and reliably.

The controller 15 functions as the operation controller, and if there are a plurality of extracted candidates, the controller 15 controls the image forming operator 14 to form a test pattern image (identification image) selected according to the plurality of candidates. That is, the controller 15 determines whether the number of candidates is 1, and if it is 1, the test pattern image is not formed. As described above, the controller 15 does not always need to extract a plurality of candidates based on the physical property measurement. If it possible to reliably specify one type, the controller 15 can control the process so that the processes that follow are not performed.

The physical property measuring unit 13 is able to obtain the measured value regarding the basis weight. The controller 15 functions as the extractor to extract the candidate of the media type based on the information regarding the physical properties including the obtained basis weight.

In addition to the surface physical property of the media M which directly relates to the forming of the image, the basis weight which is determined according to the material of the media M and the coating is added to the measured value to be obtained. Therefore, according to the image forming apparatus 1, the candidates of the media M can be extracted more reliably.

The test pattern used to specify the media type includes the image formed on both surfaces of the media M. That is, depending on the extracted candidate of the media M, the difference in the properties when an image is formed on one surface and the other surface and the influence to the other surface when the image is formed on one surface can be considered. With this, the type of the media M may be specified more suitably. Consequently, the image forming apparatus 1 is able to specify the media type more flexibly and efficiently.

The image forming apparatus 1 includes a display 43. If the controller 15 functions as the extractor to display the extracted candidates on the display 43 and the operation receiver 42 receives the input operation regarding the instruction to form the image of the test pattern, the controller 15 functions as the operation controller and controls the image forming operator 14 to form the image of the test pattern.

That is, after the physical property measuring unit 13 measures the physical properties, the image forming apparatus 1 displays on the display 43 the candidates which were once extracted and confirms whether the user is able to specify the type and make a judgment. If the user is able to specify the type, there is no need to form the image of the test pattern and the burden can be reduced. Depending on the state of connection with the post-processor, etc., the apparatus may need to be adjusted so that the user can directly take out the media M on which the test pattern is formed. Therefore, instead of forming the image of the test pattern immediately, the image can be formed after receiving consent from the user. With this, the user-friendliness is enhanced.

The image forming apparatus 1 includes a storage 17 which stores the setting (test image output setting 174) regarding whether the image forming operator 14 forms the image of the test pattern without receiving input operation regarding the image forming instruction of the test pattern after the controller 15 (extractor) extracts the candidates. The controller 15 functions as the operation controller, and when there are a plurality of extracted candidates, depending on the test image output setting 174, the controller 15 determines whether to form the test pattern image without waiting for the input operation.

That is, when there is a setting set in advance, the image of the test pattern can be output automatically without the approval by the user each time the test pattern is output. Consequently, the burden by the user can be reduced.

The controller 15 functions as the operation controller, and if the controller 15 controls the image forming operator 14 to form the image of the test pattern, the controller 15 displays on the display 43 the information (contents of the identification information T1) regarding the identification method of the above-described test pattern among the candidates.

That is, even if the user does not know the method to specify the media type, the method to specify the type can be easily understood. As described above, the candidate is narrowed down in advance by the physical property measurement and the candidates are mostly two candidates. The output test pattern is limited according to the combination of the candidates. Therefore, the portion that needs to be confirmed in the test pattern and its contents are limited. Consequently, a situation in which the user is troubled trying to understand the method of specifying hardly occurs, and the user is not troubled.

The controller 15 functions as the extractor. The controller performs evaluation of points for each of the type of plurality of media based on the data measured by the physical property measuring unit 13 and extracts the candidate of the media type according to the obtained points. That is, the candidate can be easily selected with priority from the media type with the higher possibility.

The present invention is not limited to the above-described embodiments, and various modifications are possible.

For example, according to the above-described embodiment, the number of candidates which satisfy the conditions is not specified, but at least 2 may be selected from those with low points. In this case, the user always needs to make a selection as a result of the extracting or the identification image is output (or can be output) in order to specify the type from the two candidates.

According to the above-described embodiment, the candidate is mechanically extracted based on evaluation of the points, but when the media M with high points are listed in the media type information 171 as the combination in which identification according to physical properties is difficult, the plurality of pairs of candidates can be extracted and displayed regardless of the actually calculated difference in points. Further, without using the quantitative evaluation, the media M with low possibility of applying can be simply omitted by evaluation of yes or no for each evaluation item.

The contents of the physical property measurement shown in the present embodiment is not limited to the above. For example, the color of the surface of the media M can be measured, and a degree of whiteness of the surface can be evaluated.

According to the above-described embodiment, the media M is specified based on the input operation received by the operation input unit 42. Alternatively, the displayed contents may be output to an external electronic device through the communicator 41, and a specific signal based on the operation input on the electronic device may be received by the communicator 41 in order to specify the media M.

According to the above-described embodiment, the conveyor 16 includes a reversal unit of the media M and it is possible to automatically reverse the media to form images on both surfaces. Alternatively, the user may reverse the media M output with an image formed on one side, and place the media M on the media supply tray. With this, the image forming operation can be performed on the rear surface side of the media M.

According to the above-described embodiment, the contents of the identification information T1 can be displayed on the display 43 separately from the selection screen of the media M, but alternatively, the specific contents to be selected can be displayed as the options.

According to the above-described embodiment, the image forming apparatus is an electronic photographic type, but alternatively, image forming apparatuses with other methods of forming the image can be used. For example, an inkjet type which forms an image by ejecting ink to the media M can be employed.

The specific details such as the configuration, contents of control and order as shown in the above-described embodiments can be suitably modified without leaving the scope of the present invention. The scope of the present invention should be interpreted by terms of the appended claims.

The entire disclosure of Japanese Patent Application No. 2018-131284 filed on Jul. 11, 2018 is incorporated herein by reference in its entirety.

What is claimed is:

1. An image forming apparatus comprising:
a measuring unit which measures a physical property of media as a target on which an image is formed;
an image forming operator which forms an image on the media;
a hardware processor which controls an operation of the image forming operator and which extracts a candidate of a type of media based on a measured result by the measuring unit; and
an operation receiver which receives input to specify one type from the candidate extracted by the hardware processor,
wherein, the hardware processor controls the image forming operator to form on the media an identification image determined according to a combination of the extracted candidates.

2. The image forming apparatus according to claim 1, wherein the hardware processor controls the image forming operator to form the identification image when there are a plurality of extracted candidates.

3. The image forming apparatus according to claim 1, wherein,
the measuring unit is able to obtain a measured value regarding basis weight, and
the hardware processor extracts the candidate of the type of media based on information of the physical property including the obtained basis weight.

4. The image forming apparatus according to claim 1, wherein the identification image includes an image formed on both surfaces of the media.

5. The image forming apparatus according to claim 1, further comprising a display,
wherein, the hardware processor displays the extracted candidate on the display, and the hardware processor controls the image forming operator to form the identification image when the operation receiver receives input of an instruction to form the identification image.

6. The image forming apparatus according to claim 5, further comprising a storage which stores a setting of whether the hardware processor controls the image forming operator to form the identification image without receiving input of the instruction after extracting the candidate,
wherein, the hardware processor determines whether to form the identification image without waiting for the input depending on the setting when there are a plurality of extracted candidates.

7. The image forming apparatus according to claim 1, further comprising a display,
wherein the hardware processor controls the display to display information regarding an identification method of the identification image between the candidates when the image forming operator forms the identification image.

8. The image forming apparatus according to claim 1, wherein the hardware processor performs evaluation of points for each type of the plurality of media based on the measured data by the measuring unit and extracts the candidate according to the obtained points.
